(19) United States
(12) Patent Application Publication
(10) Pub. No.: US 2026/0159319 A1
(43) Pub. Date: Jun. 11, 2026

(54) AUTONOMOUS MOBILE ROBOT WITH A TOTE MAGAZINE AND A TOTE ELEVATOR

(71) Applicant: Locus Robotics Corp., Wilmington, MA (US)

(72) Inventors: Patrick Alan Hussey, Hollis, NH (US); Jesse Mendenhall, Brookline, NH (US); Julian Ware, Waterloo (CA); Sean Johnson, Danvers, MA (US); Michael Charles Johnson, Ashland, MA (US); David Nastuk, Carlisle, MA (US); Andrew Mertinooke, Bedford, NH (US); Michael Sussman, Gloucester, MA (US); Neil Bentley, Westborough, MA (US); Robert William Deddens, Bedford, NH (US)

(21) Appl. No.: 18/972,706

(22) Filed: Dec. 6, 2024

(51) Int. Cl. B65G 1/04

(52) U.S. Cl. CPC B65G 1/0492; B65G 2201/0235

(57) ABSTRACT

An autonomous mobile robot for use in a warehouse, having a base with a top surface, a controller, and a plurality of wheels, and a tote structure on the top surface. The tote structure includes a tote magazine with vertical positions each configured to hold an order tote, a tote elevator with a platform that has two surface portions, and a lift mechanism configured to raise and lower the elevator.

### TECHNICAL FIELD

The present invention relates to an autonomous mobile robot, and more particularly to an autonomous mobile robot with a tote magazine and a tote elevator.

### BACKGROUND

Order fulfillment is typically performed in a large warehouse filled with products to be shipped to customers who have placed their orders over the internet for home delivery. Clicking the “check out” button in a virtual shopping cart creates an “order”. The order includes a listing of items that are to be shipped to a particular address. The process of “fulfillment” involves physically taking or “picking” these items from a large warehouse, packing them, and shipping them to the designated address. An important goal of the order fulfillment process is to ship as many items in as short a time as possible. In some operations, robots may be used for item retrieval to increase productivity and efficiency. Autonomous mobile robots capable of navigating a warehouse and picking items for an order without human assistance are desirable due to their increased efficiency.

### SUMMARY OF THE EMBODIMENTS

In accordance with one embodiment of the invention, an autonomous mobile robot for use in a warehouse including one or more storage units for holding a plurality of source totes each associated with one or more items comprises a mobile robot base including a base body having a top surface, a controller, and a plurality of wheels, and a tote structure disposed on the top surface of the base body. The tote structure includes a tote magazine having a plurality of positions vertically disposed relative to the top surface of the base body, where each position is configured to hold at least one order tote. The tote structure further includes a tote elevator having a platform positioned adjacent to the tote magazine, wherein the platform includes a first surface portion configured to receive a source tote retrieved from the one or more storage units and a second surface portion adjacent to the first surface portion and configured to receive an order tote from the tote magazine, and a lift mechanism, responsive to the controller, configured to raise and lower the tote elevator relative to the top surface of the base body.

The first surface portion of the platform may include a tote manipulator mechanism, responsive to the controller, configured to extend from a retracted position to an extended position and to retract from an extended position to a retracted position, and wherein the direction of travel of the tote manipulator mechanism is perpendicular to a length of the platform. The tote manipulator mechanism may be, responsive to the controller, configured to engage with a source tote of the plurality of source totes when in the extended position and to retract the engaged source tote to the retracted position on the first surface portion of the platform. The tote manipulator mechanism may include a tote manipulator device configured to engage with the source tote, and the tote manipulator device may be connected to a translation device configured to move the tote manipulator device in a direction perpendicular to the length of the platform. The second surface portion may include a tote transfer mechanism, responsive to the controller, configured to move in a direction parallel to the length of the platform from proximate the tote magazine across the second surface portion to the first surface portion. The tote transfer mechanism may include at least one projection configured to engage an order tote positioned in the tote magazine, the at least one projection connected to a translation device configured to transfer the order tote from the tote magazine to the second surface portion on the platform and from the second surface portion on the platform to the tote magazine. The tote elevator may be configured to be raised and lowered by the lift mechanism, responsive to the controller, to selectively align the second surface portion of the platform with each of the vertically disposed positions of the tote magazine. The tote elevator may include a robotic pick arm having an imaging system and a gripper device, the robotic pick arm being disposed above the surface of the platform and secured to a mounting mechanism. The mounting mechanism may be, responsive to the controller, configured to move the robotic pick arm between the first surface portion of the platform and the second surface portion of the platform.

The controller may be configured to: navigate the mobile robot base to a position adjacent to a storage unit having a source tote associated with an identified item; cause the lift mechanism to align the platform of the elevator with a height of a position of the plurality of vertically disposed positions in the tote magazine having an order tote associated with the identified item; cause the tote transfer mechanism to retrieve the order tote from the position in the tote magazine and move the retrieved order tote to the second surface portion of the platform; cause the lift mechanism to align the platform of the elevator with a height of the source tote on the storage unit; and cause the tote manipulator mechanism to engage the source tote and retract the source tote to the retracted position on the first surface portion of the platform. The controller may be further configured to: cause the robot pick arm to locate the identified item using the imaging system in one of the source tote or the order tote and pick the identified item using the gripper device; and cause the robot pick arm to move to the other of the source tote or the order tote and to drop the identified item from the gripper device into the other of the source tote or the order tote. The plurality of wheels may be mecanum wheels.

In another embodiment, an autonomous mobile robot for use in a warehouse including one or more storage units for holding a plurality of source totes each associated with one or more items comprises a mobile robot base including a base body having a top surface, a controller, and a plurality of wheels, and a tote structure disposed on the top surface of the base body. The tote structure includes a tote magazine having a plurality of positions vertically disposed relative to the top surface of the base body, where each position is configured to hold at least one order tote. The tote structure further includes a tote elevator having a platform positioned adjacent to the tote magazine, wherein the platform includes a first surface portion configured to receive a source tote retrieved from the one or more storage units and a second surface portion adjacent to the first surface portion and configured to receive an order tote from the tote magazine, and a lift mechanism, responsive to the controller, configured to raise and lower the tote elevator relative to the top surface of the base body. The first surface portion of the platform includes a tote manipulator mechanism, responsive to the controller, to extend from a retracted position to an extended position and to retract from the extended position to the retracted position; and wherein a direction of travel of the tote manipulator mechanism is perpendicular to a length of the platform. The second surface portion includes a tote transfer mechanism, responsive to the controller, configured to move in a direction parallel to the length of the platform from proximate the tote magazine across the second surface portion to the first surface portion.

The tote manipulator mechanism may be, responsive to the controller, configured to engage with a source tote of the plurality of source totes when in the extended position and to retract the engaged source tote to the retracted position on the first surface portion of the platform. The tote manipulator mechanism may include a tote manipulator device configured to engage with the source tote, and the tote manipulator device may be connected to a translation device configured to move the tote manipulator device in a direction perpendicular to the length of the platform. The tote transfer mechanism may include at least one projection configured to engage an order tote positioned in the tote magazine, the at least one projection connected to a translation device configured to transfer the order tote from the tote magazine to the second surface portion on the platform and from the second surface portion on the platform to the tote magazine. The tote elevator may be configured to be raised and lowered by the lift mechanism, responsive to the controller, to selectively align the second surface portion of the platform with each of the vertically disposed positions of the tote magazine. The tote elevator may include a robotic pick arm having an imaging system and a gripper device, the robotic pick arm being disposed above the surface of the platform and secured to a mounting mechanism. The mounting mechanism may be, responsive to the controller, configured to move the robotic pick arm between the first surface portion of the platform and the second surface portion of the platform.

The controller may be configured to: navigate the mobile robot base to a position adjacent to a storage unit having a source tote associated with an identified item; cause the lift mechanism to align the platform of the elevator with a height of a position of the plurality of vertically disposed positions in the tote magazine having an order tote associated with the identified item; cause the tote transfer mechanism to retrieve the order tote from the position in the tote magazine and move the retrieved order tote to the second surface portion of the platform; cause the lift mechanism to align the platform of the elevator with a height of the source tote on the storage unit; and cause the tote manipulator mechanism to engage the source tote and retract the source tote to the retracted position on the first surface portion of the platform. The controller may be further configured to: cause the robot pick arm to locate the identified item using the imaging system in one of the source tote or the order tote and pick the identified item using the gripper device; and cause the robot pick arm to move to the other of the source tote or the order tote and to drop the identified item from the gripper device into the other of the source tote or the order tote. The plurality of wheels may be mecanum wheels.

### BRIEF DESCRIPTION OF THE DRAWINGS

The foregoing features of embodiments will be more readily understood by reference to the following detailed description, taken with reference to the accompanying drawings, in which:

FIG. 1A is a view of an autonomous mobile robot with a tote magazine and a tote elevator.

FIG. 1B is a view of the robot of FIG. 1A next to a shelving unit.

FIG. 2 is a view of the robot of FIG. 1A with a tote on both positions on the elevator.

FIG. 3 is a view of the elevator carriage.

FIG. 4A is a view of the robot of FIG. 1A with the elevator moving up and down.

FIG. 4B is a view of the robot of FIG. 1A with a tote being moved by a tote transfer mechanism.

FIG. 4C is a view of the robot of FIG. 1A with a tote being moved by a tote manipulator.

FIG. 5 is a diagram of an embodiment of a robot control system.

FIG. 6A is a view of the robot of FIG. 1A moving a tote from the magazine to the elevator carriage.

FIG. 6B is a view of the robot of FIG. 1A moving the elevator carriage to the level of a shelf.

FIG. 6C is a view of the robot of FIG. 1A moving to a target pose beside a shelving unit.

FIG. 6D is a view of a camera on the side of the elevator carriage viewing a label on a tote.

FIG. 7A is a view of an embodiment of a tote manipulator with pneumatic suction cups.

FIG. 7B is a view of the tote manipulator of FIG. 7A, with the suction cups flipped around.

FIG. 7C is a view of the tote manipulator of FIG. 7A in a fully extended position.

FIG. 7D is a view of tote manipulator of FIG. 7A in a fully extended position and engaged with a tote.

FIG. 7E is a view of another embodiment of a tote manipulator with a mechanical gripper.

FIG. 7F is a view of the tote manipulator of FIG. 7E engaged with a tote.

FIG. 8A is a view of a tote transfer mechanism with fingers up.

FIG. 8B is a view of the tote transfer mechanism of FIG. 8A with fingers down.

FIG. 8C is a view of the tote transfer mechanism of FIG. 8A engaged with a tote.

FIG. 8D is a view of the tote transfer mechanism of FIG. 8A pulling a tote.

FIG. 8E is a view of the tote transfer mechanism of FIG. 8A pushing a tote.

FIG. 9A is a view of a robot arm imaging a source tote.

FIG. 9B is a view of item segmentation being performed on the contents of a source tote.

FIG. 9C is a view of pick targeting being performed on the segmented items of FIG. 9C.

FIG. 10A is a top view of the robot of FIG. 1A picking an item from a source tote with a robot arm.

FIG. 10B is a top view of the robot of FIG. 1A placing an item into an order tote with the robot arm.

FIG. 11 is a diagram of a system architecture that may be used to control robots like the robot of FIG. 1A.

FIG. 12 is a top plan view of an order fulfillment warehouse.

FIG. 12A is a view of the robot of FIG. 1A inducting empty order totes.

FIG. 12B is a view of the robot of FIG. 1A engaging with an empty order tote during induction.

FIG. 12C is a view of the robot of FIG. 1A pulling an empty order tote onto its elevator carriage during induction.

FIG. 12D is a view of the robot of FIG. 1A performing packout.

FIG. 12E is a view of the robot of FIG. 1A moving a tote from its elevator carriage to a conveyor during packout.

FIG. 12F is a diagram of a variety of workflows the robot of FIG. 1A may perform.

FIG. 13 is a diagram of several levels of prioritization the robot of FIG. 1A may perform.

FIG. 14A is a side view of a pick location within a warehouse.

FIG. 14B is a top view of a segmented source tote.

FIG. 15 is a diagram view of an embodiment of a computer system.

### DETAILED DESCRIPTION OF SPECIFIC EMBODIMENTS

Various embodiments are described herein of an autonomous mobile robot (“AMR”, “robot”) having a base and a tote structure including a vertically-oriented tote magazine, and an elevator carriage disposed adjacent to the tote magazine and configured to move vertically relative to the base. The tote magazine is configured to hold a plurality of totes, e.g., order totes. The elevator carriage has a platform comprising two positions, an order tote queue position, which is located proximate to the tote magazine, and a source tote position, which is located adjacent to the order tote queue position and distal to the tote magazine. The elevator carriage may further comprise a tote transfer mechanism configured to move totes between the tote magazine, the order tote queue position, and the source tote position, and a tote manipulator mechanism configured to engage with totes, e.g., source totes, and move them from a shelving unit to the source tote position, and vice versa. The tote manipulator may be configured to engage with totes on either side of the robot, and move them from a shelving unit to the source tote position, or vice versa. The elevator carriage may further comprise a mounted robot arm (“arm”) configured to grab and move items from a tote on the source tote position to a tote on the order tote queue position, and vice versa.

The robot may improve warehouse efficiency of order picking and item put-away (“pick and place”) by fully automating the pick and place process, and by pre-queueing totes and the elevator carriage en route to the picking or placing destination. For example, in one workflow, the robot may move an order tote from the tote magazine onto the order tote queue position and then raise the elevator carriage such that the platform is at a height of the source tote containing the next item to be picked while the robot is driving to the location in the warehouse of that source tote. Therefore, when the robot reaches the source tote, the tote manipulator can immediately engage with the source tote, pull the source tote onto the source tote position of the platform, use the robot arm to grab an item from the source tote and place the item into the order tote, and then move the source tote back onto the shelf. Once the source tote has been replaced on the shelf, the robot can begin moving toward the location of the next source tote and meanwhile, replace the order tote onto the tote magazine, move the next order tote to the order tote queue position, and move the elevator carriage to the vertical position of the next source tote.

The robot may comprise systems and perform methods as described in the following patents, the contents of each are hereby incorporated, in their entirety, by reference: U.S. Pat. No. 10,429,847 (Dynamic Window Approach Using Optimal Reciprocal Collision Avoidance Cost-Critic); U.S. Pat. No. 10,401,864 (Electrical Charging System and Method for an Autonomous Robot); U.S. Pat. No. 10,243,379 (Robot Charging Station Protective Member); U.S. Pat. No. 10,579,064 (Autonomous Robot Charging Profile Selection); U.S. Pat. No. 10,399,443 (Autonomous Robot Charging Station); U.S. Pat. No. 10,386,851 (Multi-Resolution Scan Matching with Exclusion Zones); U.S. Pat. No. 9,776,324 (Robot Queueing in Order-Fulfillment Operations); U.S. Pat. No. 10,793,357 (Robot Dwell Time Minimization in Warehouse Order Fulfillment Operations); U.S. Pat. No. 11,213,950 (Proximate Robot Object Detection and Avoidance); U.S. Pat. No. 11,724,395 (Robot Congestion Management); U.S. Pat. No. 11,493,925 (Robot Obstacle Collision Prediction and Avoidance); U.S. Pat. No. 9,758,305 (Robotic Navigation Utilizing Semantic Mapping); U.S. Pat. No. 10,572,854 (Order Grouping in Warehouse Order Fulfillment Operations).

### Exemplary Robot Design and Operation

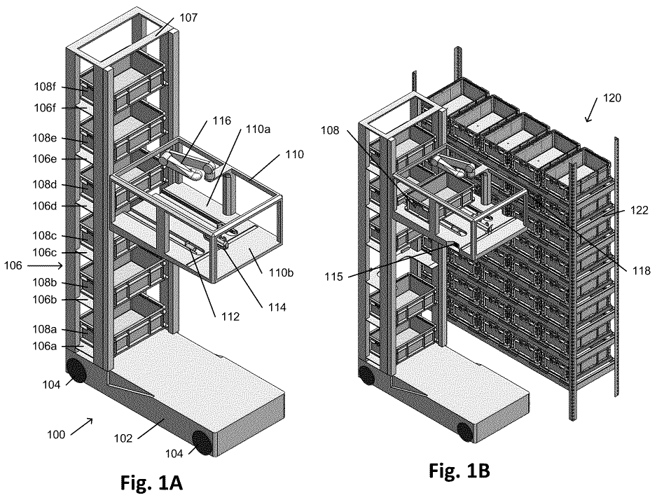

FIG. 1A shows an embodiment of an autonomous mobile robot 100. The robot 100 comprises a base 102 having a plurality of wheels 104, which may be mecanum wheels, and a robot control system (not shown), a tote magazine 106, and an elevator carriage 110.

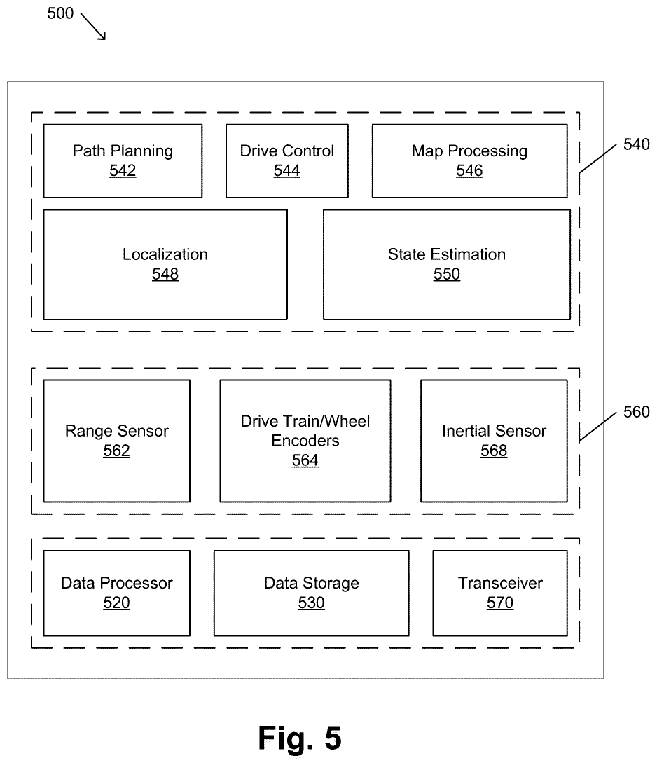

The robot control system may, for example, be implemented as shown in FIG. 5 and described below. The tote magazine 106 comprises a frame 107 and one or more tote magazine positions 106a-106f. The tote magazine position(s) may be in a single vertical column, a single horizontal row, or multiple vertical columns and/or horizontal rows. There may be more or fewer than six tote magazine positions. The tote magazine positions 106a-106fmay be platforms (which may have cutouts as shown in FIG. 1B, which may accommodate a tote transfer mechanism as described below) and are configured to each hold a tote, such as an order tote 108. As shown in FIG. 1A, each of the tote magazine positions 106a-106f holds a respective order tote 108a-108f. The elevator carriage 110 has a platform comprising two tote positions: an order tote queue position 110a; and a source tote position 110b. The elevator carriage 110 further comprises a tote transfer mechanism 112, which may move totes between the tote magazine 106, the order tote queue position 110a, and the source tote position 110b. The elevator carriage also comprises a tote manipulator mechanism (“tote manipulator”) 114, which can physically engage with totes on a shelf (such as shelf 122), conveyor belt, platform, or that are otherwise adjacent to the elevator carriage 110, and pull them onto the source tote position 110b. The tote manipulator 114 can also engage with totes already on the source tote position 110b and move them onto a shelf, conveyor belt, platform, etc. The tote manipulator 114 may be capable of engaging with totes on either the left side of the robot 100 or the right side of the robot 100, so that the robot 100 can engage with totes on both sides of an aisle in a warehouse without needing to turn around. The tote manipulator may be capable of extending beyond each side of the elevator platform in order to reach totes. If the wheels 104 are mecanum wheels, the robot 100 may be capable of translating from one side of an aisle to the other without needing to turn, so that the robot 100 can access shelving units on both sides of the aisle quickly and easily.

The elevator carriage 110 also comprises a robot arm 116, which may be mounted between the order tote queue position 110a and the source tote position 110b, and is configured to grab, using a grabber, one or more items from a tote in one of the tote positions 110a & 110b on the platform and place it in a tote in the other of the tote positions 110b & 110 a. The robot arm 116 may be a multi-degree of freedom arm, such as a such as a 6-axis, 7-axis, or 8-axis arm. The robot arm 116 may comprise a robot arm camera and operate using software capable of identifying, based on one or more images from the camera, particular items in a tote to grab, as well as segmenting items, counting items in a tote, identifying incorrect items, and more.

As shown in FIG. 1B, the elevator carriage 110 may also have cameras 115 built into the sides of the platform, which may be configured to recognize fiducials (e.g., barcodes, QR codes, April Tags, etc.), including fiducials on shelves and fiducials on totes. For example, by recognizing a barcode on a source tote 118, the robot 100 may determine whether it has reached the correct source tote 118 and begin the item picking workflow. The cameras may also enable the robot 100 to align the elevator carriage 110 with the shelf 122 holding the target source tote 118, and with the position on the shelf 122 containing the target source tote 118, so that the tote manipulator 114 can engage with the target source tote 118 and pull it onto the source tote position 110b. The elevator carriage may comprise sensors to detect when a tote is in the order tote queue position 110a and the source tote position 110b. The elevator carriage may also have a sensor positioned at the vertical level of the height of a tote, which can detect if items are sticking out.

FIG. 1B shows an embodiment of a robot 100 executing a workflow, e.g., a “pick” workflow. The robot 100 has navigated through a warehouse to a shelving unit 120, and, along the way, has transferred an order tote 108 from the tote magazine 106 to the order tote queue position 110a and raised the elevator carriage 110 to the level of the shelf 122 containing the target source tote 118. Upon reaching the location of the target source tote 118, the robot 100 may use LIDAR sensors on the base 102 (e.g., positioned at the corners of the base 102) to perform rough alignment with the shelving unit 120, and the robot may further use images of fiducials from the camera 115 facing the shelf 122 to perform fine alignment movements to align the source tote position 110b of the elevator carriage with the shelf position of the target source tote 118. This allows the tote manipulator 114 to engage with (i.e., grab) the target source tote 118 and pull it onto the source tote position 110b of the elevator carriage 110. The robot arm 116 may then identify and grab an item from the target source tote 118 and place it in the order tote 108. Then the tote manipulator 114 can push the target source tote 118 back onto the shelf 122.

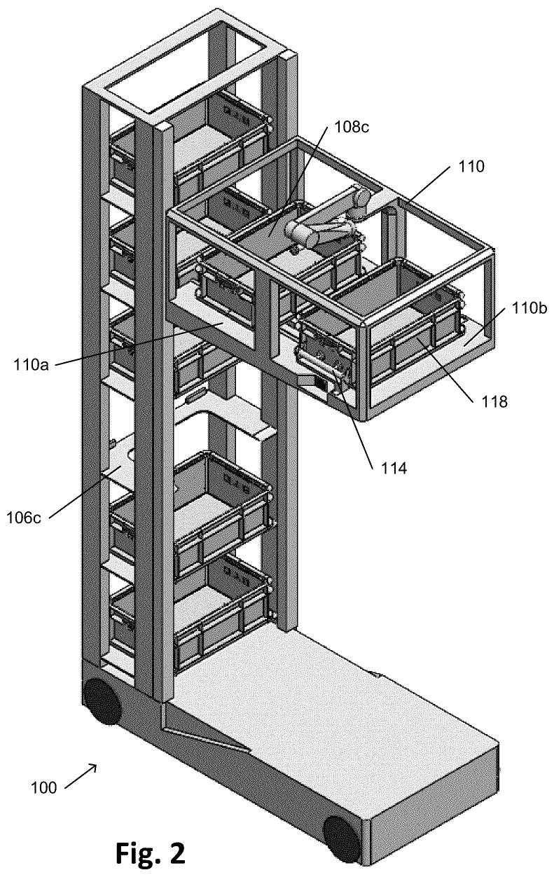

FIG. 2 shows an embodiment of a robot 100 performing a workflow. The robot 100 has moved order tote 108c from its tote magazine position 106c to the order tote queue position 110a of the elevator carriage 110 using the tote transfer mechanism 112 (not clearly shown). The robot 100 has also used the tote manipulator 114 to engage with a source tote 118 and move it onto the source tote position 110b. Thus, the robot 100 is in a state where both positions 110a & 110b on the platform of the elevator carriage 110 have a tote on them. When in this position, the arm 116 can grab items from one of the totes and move the items to the other of the totes.

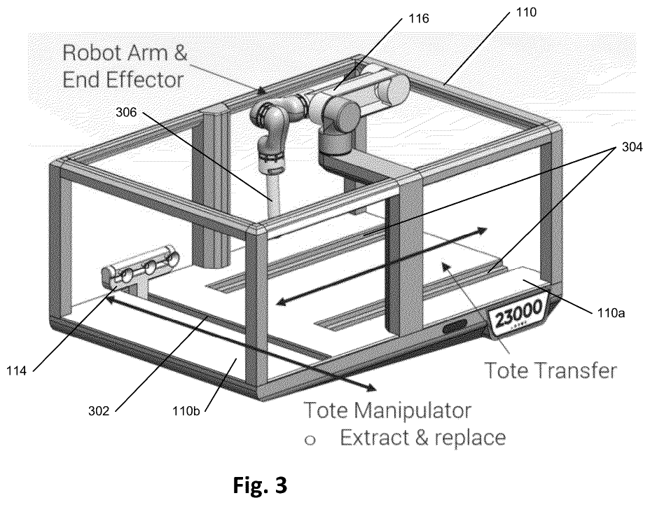

FIG. 3 shows an embodiment of an elevator carriage 110. The tote manipulator 114 may be configured to move from the left side of the elevator carriage to the right side of the elevator carriage, and vice versa, through a slot in the source tote position 110b of the platform. The tote transfer mechanism 112 (not shown here) may similarly function via movement in one or more parallel slots (e.g., two slots, as shown in FIG. 3) 304 in the platform, and may be configured to engage with the bottom of totes in order to move them between the tote magazine 106, order tote queue position 110a, and source tote position 110b. The robot arm 116 may be equipped with an end effector 306 (partially obscured), which can engage with items in a tote in order to pick them up, move them to another tote, and release them. Although not shown, the elevator carriage 110 may have guidance bumpers configured to keep totes in alignment as they are moved from position to position.

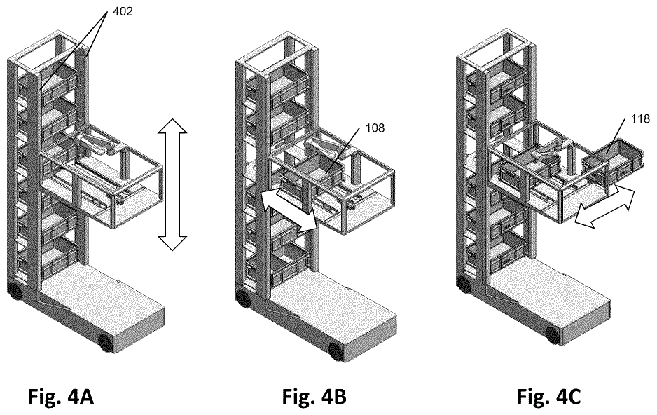

FIGS. 4A, 4B, and 4C show various movement functions of an embodiment of a robot 100. As shown in FIG. 4A, as indicated by the arrow, the elevator carriage 110 may be raised or lowered, e.g., via a linear actuator, relative to the base of the robot 100. For example, a belt-driven elevator system 402 (shown in simplified form) may be disposed on the front posts of the tote magazine frame 107, to which the elevator carriage 110 is connected. As shown in FIG. 4B, as indicated by the arrow, the tote transfer mechanism 112 can move a tote 108 from the tote magazine 106 to the order tote queue position 110a (and vice versa). As shown in FIG. 4C, the tote manipulator 114 can pull source totes 118 from a position adjacent to the robot 100, such as on a shelf, onto the source tote position 110b (and vice versa). Although FIG. 4C shows the tote manipulator 114 engaging with a tote 118 that is to the left (i.e., port) side of the robot 100, the tote manipulator 114 can also engage with totes to the right (i.e., starboard) side of the robot 100.

FIG. 5 illustrates one embodiment of a robot control system of robot 100 for use in the above described order fulfillment warehouse application. Robot control system 500 may comprise data processor 520, data storage 530, processing modules 540, and sensor support modules 560. Processing modules 540 may include path planning module 542, drive control module 544, map processing module 546, localization module 548, and state estimation module 550. Sensor support modules 560 may include range sensor module 562, drive train/wheel encoder module 564, and inertial sensor module 568.

Data processor 520, processing modules 542 and sensor support modules 560 are capable of communicating with any of the components, devices or modules herein shown or described for robot control system 500. A transceiver module 570 may be included to transmit and receive data. Transceiver module 570 may transmit and receive data and information to and from a supervisor system or to and from one or other robots. Transmitting and receiving data may include map data, path data, search data, sensor data, location and orientation data, velocity data, and processing module instructions or code, robot parameter and environment settings, and other data necessary to the operation of robot control system 500.

In some embodiments, range sensor module 562 may comprise one or more of a scanning laser, radar, laser range finder, range finder, ultrasonic obstacle detector, a stereo vision system, a monocular vision system, a camera, and an imaging unit. Range sensor module 562 may scan an environment around the robot to determine a location of one or more obstacles with respect to the robot. In a preferred embodiment, drive train/wheel encoders 564 comprises one or more sensors for encoding wheel position and an actuator for controlling the position of one or more wheels (e.g., ground engaging wheels). Robot system 500 may also include a ground speed sensor comprising a speedometer or radar-based sensor or a rotational velocity sensor. The rotational velocity sensor may comprise the combination of an accelerometer and an integrator. The rotational velocity sensor may provide an observed rotational velocity for the data processor 520, or any module thereof.

In some embodiments, sensor support modules 560 may provide translational data, position data, rotation data, level data, inertial data, and heading data, including historical data of instantaneous measures of velocity, translation, position, rotation, level, heading, and inertial data over time. The translational or rotational velocity may be detected with reference to one or more fixed reference points or stationary objects in the robot environment. Translational velocity may be expressed as an absolute speed in a direction or as a first derivative of robot position versus time. Rotational velocity may be expressed as a speed in angular units or as the first derivative of the angular position versus time.

Translational and rotational velocity may be expressed with respect to an origin 0,0 and bearing of 0-degrees relative to an absolute or relative coordinate system. Processing modules 540 may use the observed translational velocity (or position versus time measurements) combined with detected rotational velocity to estimate observed rotational velocity of the robot.

In other embodiments, modules not shown in FIG. 5 may comprise a steering system, braking system, and propulsion system. The braking system may comprise a hydraulic braking system, an electro-hydraulic braking system, an electro-mechanical braking system, an electromechanical actuator, an electrical braking system, a brake-by-wire braking system, or another braking system in communication with drive control 544. The propulsion system may comprise an electric motor, a drive motor, an alternating current motor, an induction motor, a permanent magnet motor, a direct current motor, or another suitable motor for propelling a robot.

The propulsion system may comprise a motor controller (e.g., an inverter, chopper, wave generator, a multiphase controller, variable frequency oscillator, variable current supply, or variable voltage supply) for controlling at least one of the velocity, torque, and direction of rotation of the motor shaft of the electric motor. Drive control 544 and propulsion system (not shown) may be a holomonic drive system or may be a differential drive (DD) control and propulsion system. In a DD control system robot control is non-holonomic (NH), characterized by constraints on the achievable incremental path given a desired translational and angular velocity. Drive control 544 in communication with propulsion system may actuate incremental movement of the robot by converting one or more instantaneous velocities determined by path planning module 542 or data processor 520.

One skilled in the art would recognize other systems and techniques for robot processing, data storage, sensing, control and propulsion may be employed without loss of applicability of the present invention described herein.

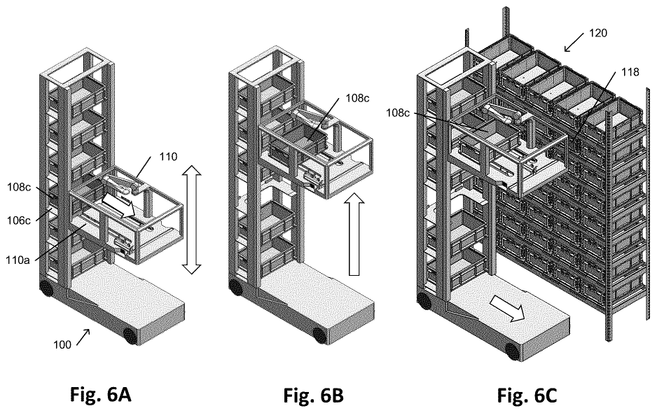

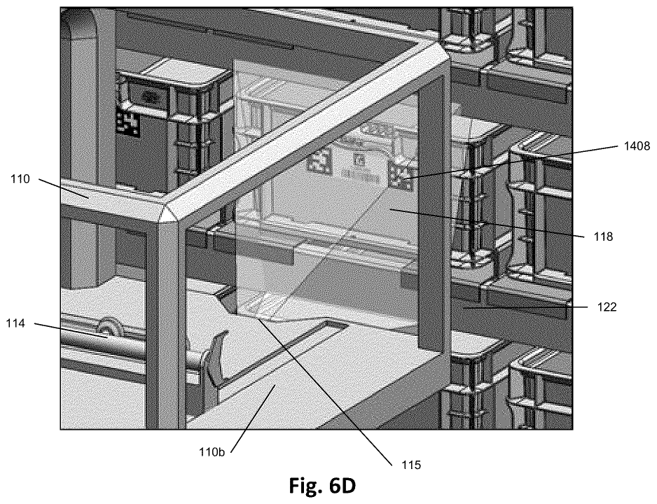

FIGS. 6A, 6B, and 6C show a demonstration of an embodiment of a robot 100 performing tote pre-queueing while en route to a destination. Pre-queueing is a process wherein the robot 100 configures itself, while traveling to a destination, to be ready to perform a task function immediately (or nearly immediately) upon arrival to a destination, i.e., a destination pose. Pre-queueing may involve placing particular totes in the tote magazine 106, the order tote queue position 110a, and/or the source tote position 110b, as well as positioning the elevator carriage 110 at a height which corresponds to a height of a shelf, conveyor belt, platform, etc., at the destination. The positioning of the elevator carriage during pre-queueing may be approximate, e.g., within 20 cm, 10 cm, 5 cm, or 1 cm, of the height of the destination shelf. The robot 100 may perform fine adjustments upon reaching a destination to align the elevator carriage with the shelf and ensure that totes can be smoothly moved between the source tote position 110b and the shelf by the tote manipulator 114. The robot may maintain a safety buffer of approximately 200 mm between the robot and the shelves, and, upon reaching the destination reduce the buffer to 150 mm while detecting (e.g., with a camera) if there is a person between it and the shelves. Upon failing to detect a person in between the robot and the shelves, the safety buffer may be muted and the robot may strafe to a nominal 50 mm from the shelves.

In FIG. 6A, a robot 100 has received, for example, a pick task involving order tote 108c. The robot 100 may determine a destination pose in the warehouse using semantic mapping. For example, the robot 100 (and/or the WMS 1102) may have, in memory, a SKU number associated with an item, the SKU number having a correlated bin number, which has a correlated shelf number and shelf position number, which is correlated with a shelving unit, which is correlated with a fiducial, which is correlated with a pose. The robot 100 may then begin traveling to the destination pose in the warehouse using its navigation capability. Additional details on semantic mapping may be found, for example, in U.S. Pat. No. 9,758,305 (Robotic Navigation Utilizing Semantic Mapping). While traveling, the robot may raise or lower the elevator carriage 110 to align the platform of the elevator carriage 110—specifically, the order tote queue position 110a—with the tote magazine position 106c. After aligning the elevator carriage 110, the tote transfer mechanism 112 may, even while moving, engage with the order tote 108c and move it onto the order tote queue position 110a. As shown in FIG. 6B, the robot 100 may then (even while still moving) position the elevator carriage 110 at a height of the shelf of the target source tote 118. As shown in FIG. 6C, the robot 100 continues traveling until it reaches the destination shelving unit 120, and then the shelf position that is the location of the target source tote 118. The robot may determine that it has reached the destination shelving unit 120 by recognizing a fiducial on or near the destination shelving unit 120. The robot 100 may then perform fine alignment in order to align the elevator carriage—specifically, the source tote position 110b—with the shelf (and shelf position) holding target source tote 118. Then, the robot 100 may begin the pick operation by pulling the target source tote 118 onto the source tote position 110b, picking an item from it using the robot arm 116, placing the item into the order tote 108c, and then placing the target source tote 118 back on the shelf with the tote manipulator 114. By engaging in pre-queueing, the robot 100 did not have to waste time preparing itself to commence the pick operation at the destination, and therefore its efficiency is improved. While on the way to the next item to be picked, the robot may use the elevator and tote transfer mechanism 112 to place the order tote 108c back onto its tote magazine position 106c, pull the order tote pertaining to the next item onto the order tote queue position, and adjust the elevator carriage 110 height for the next item. Thus, pre-queueing may happen before each pick or place (or other) operation.

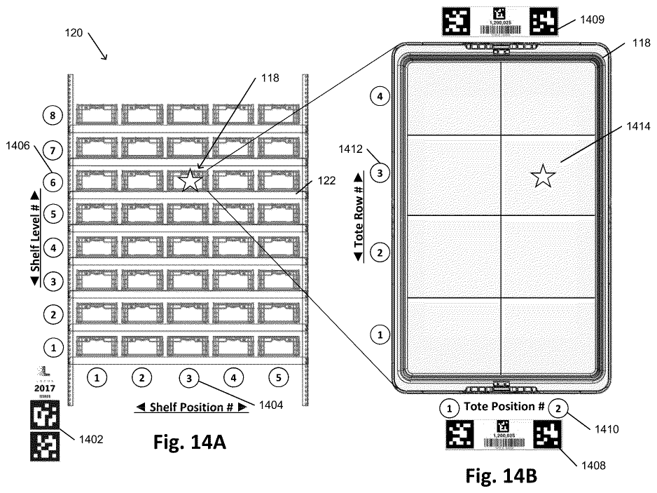

FIG. 6D shows an example of the fine alignment process of a robot 100. A camera 115, mounted on an elevator carriage 110 proximate to the source tote position 110b (e.g., on the side of the elevator carriage platform), scans the target source tote 118 and the shelf 122. The camera 115 may have a light proximate to it. The robot 100 may identify the target source tote 118 by scanning (and/or recognizing) the tote identification label 1408 (which will be described further in relation to FIG. 14). The robot 100 may, based on the scanned image from the camera 115, adjust position of the robot 100 and/or of the elevator carriage 110 in order to align the source tote position 110b with the shelf 122 and the tote manipulator 114 with the target source tote 118. The shelf 122 may additionally have a shelf position label (not shown) on it for each tote position on the shelf 122. The robot 100 may detect, via the camera image, whether the tote identification label 1408 is aligned with the corresponding shelf position label, enabling the robot to, if they are not aligned, use the tote manipulator 114 to grab and realign the source tote 118.

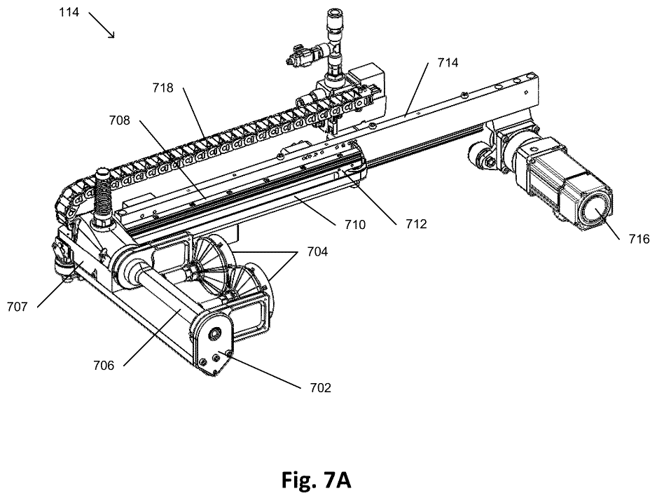

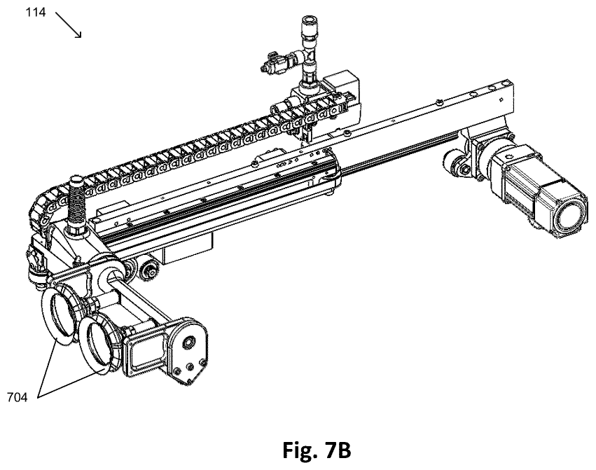

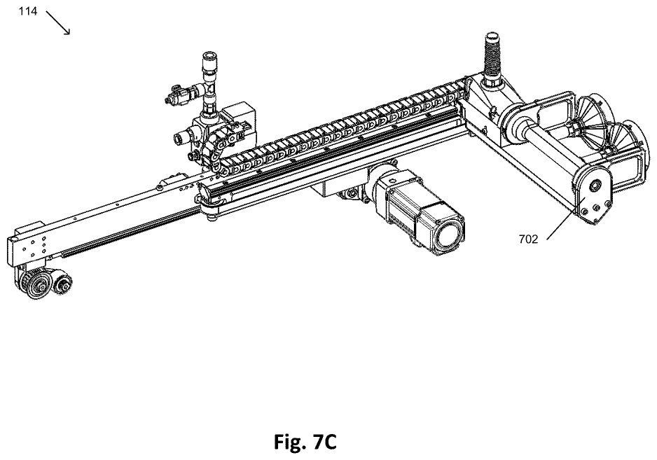

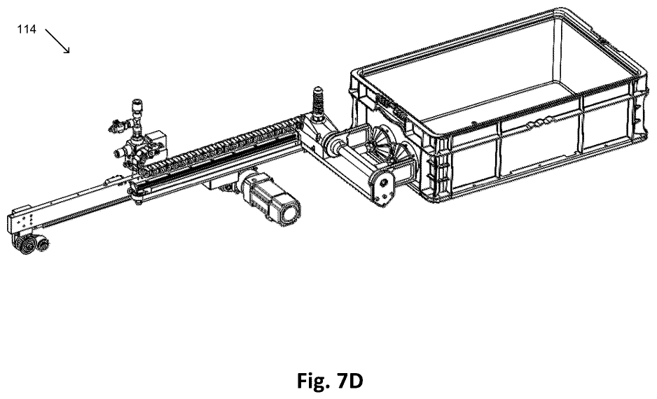

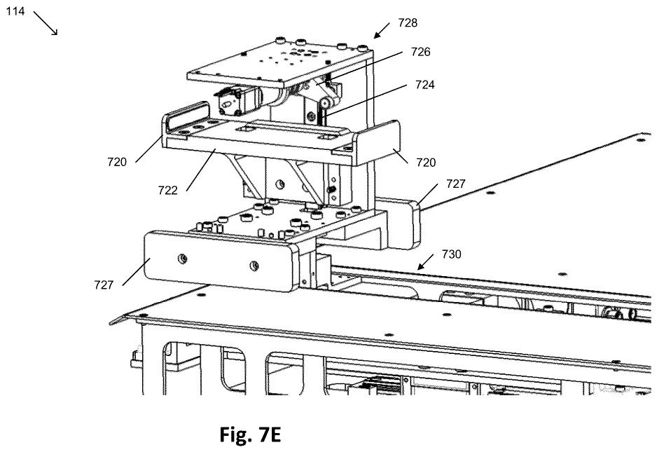

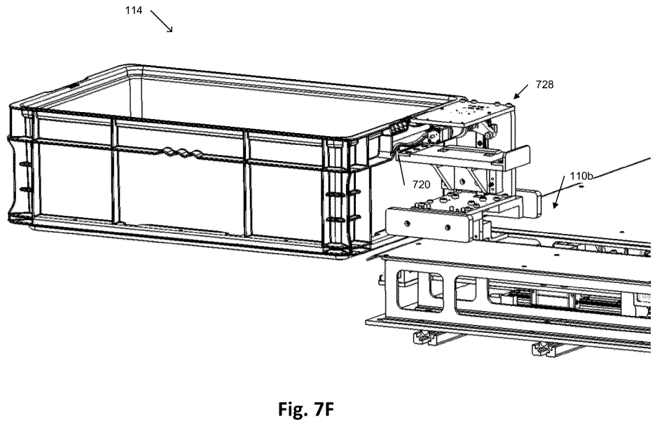

FIGS. 7A, 7B, 7C, and 7D show an example of a tote manipulator 114. In FIG. 7A, the tote manipulator 114 is shown in a “fully retracted” state. The tote manipulator 114 may be in the fully retracted state when a tote is in the source tote position 110b or when the robot 100 is anticipating a tote being moved into the source tote position 110b by the tote transfer mechanism 112.

As shown in FIG. 7A, the example of the tote manipulator 114 comprises an end effector assembly 702, which itself comprises one or more suction cups 704, and a manifold 706, the suction cups 704 being mounted on and fluidly connected to the manifold 706. The end effector assembly 702 also comprises a motor, such as a stepper motor 707, configured to rotate the suction cups 704 and the manifold 706 about an axis 180 degrees. The manifold 706 is fluidly connected to a vacuum pump (not shown), which when activated, may cause the suction cups 704 to engage with a surface, such as a side of a tote, when the suction cups 704 are in contact with that surface. The tote manipulator 117 may also comprise an energy chain 718, or other flexible conduit, through which wires carrying power and signals to the end effector assembly may be run.

The end effector assembly 702 is mounted on a first mounting rail 708 via, for example, a linear bearing (not shown). The end effector assembly 702 is also affixed to a first belt 710, via, e.g., a belt clamp. The first mounting rail 708 and the first belt 710 are components of a telescoping assembly 712. The telescoping assembly 712 is itself mounted on a second mounting rail 714, via, e.g., a linear bearing, and affixed to a second belt (not shown). The first belt 710 and the second belt are both driven, in tandem, by a motor 716. The first belt 710 and the second belt have different drive ratios (e.g., 2:1 for the first belt and 1:1 for the second belt), which causes the end effector assembly 702 to move to the other end of the first mounting rail 708 as the telescoping assembly 712 moves to the other end of the second mounting rail 714. This enables the telescoping action.

Both motors 707 and 716, and the vacuum pump, are connected to a controller (not shown), which may comprise a processor and a memory. The controller may also be communicatively connected to a position sensor in each motor, a home position sensor on each mounting rail 708 and 714, and on the end effector assembly 702, to calibrate the positions of the mounting rails and the orientation of the suction cups, and a pressure sensor, e.g., within the manifold 706, to sense the vacuum pressure and detect leaks. The vacuum pump may be activated to maintain a certain vacuum pressure in the suction cups 704. By detecting leaks, leak severity, and leak frequency, the controller may be able to measure degradation of performance of the suction cups 704.

FIG. 7B shows an example of a tote manipulator 114 with the suction cups 704 flipped around. This capability, as well as bidirectionality of the motor 716, enables the tote manipulator 114 to engage with totes on either side of the robot 100.

FIG. 7C shows an example of a tote manipulator 114 in the “fully extended” state, wherein the end effector assembly 702 is at its maximum displacement from the center of the elevator carriage 110, and the telescoping assembly 712 is also at its maximum displacement. The tote manipulator 114 may be in the fully extended state when it is retrieving a tote from a shelf or placing a tote onto a shelf. As a note, the fully extended state may be achieved on either side, and in each case, the suction cups 704 will be facing outwards. Similarly, the fully retracted state may be achieved on either side, and in each case, the suction cups 704 will be facing inwards. The fully extended state may result in the end effector assembly 702 being positioned near the edge, at the edge, or even beyond the edge of the elevator carriage 110.

FIG. 7D shows an example of a tote manipulator 114 in the fully extended state with the suction cups 704 engaged with a tote. In this situation, the vacuum pump may be creating a vacuum through the manifold 706 and the suction cups 704, which each create a seal against the surface of the tote, enabling the tote to be moved back and forth via the motor 716. The vacuum pump may turn off when the tote manipulator 114 is disengaging from the tote.

FIGS. 7E and 7F show another example of a tote manipulator 114, wherein the tote manipulator 114 comprises two grip tabs 720, disposed on opposite ends of a reciprocating bracket 722. The grip tabs 720 are configured to engage with the handle of a tote so that the tote manipulator can move the tote from a shelf to the source tote position 110b, and vice versa. The reciprocating bracket 722 is mounted to a vertically oriented linear actuator, which may include a vertical mounting rail 724, a spring-loaded cam and follower mechanism (not shown) and a motor 726. The vertically oriented linear actuator has a “down” position, which is positioned such that the outwardly facing grip tab 720 is below the level of the handle on the tote when the elevator carriage 110 is aligned with the level of a shelf. The vertically oriented linear actuator also has an “up” position, which is positioned such that the outwardly facing grip tab 720 will engage with the handle of the tote when the elevator carriage 110 is aligned with the level of the shelf. The tote manipulator 114 may also comprise one or more push plates 727, which help maintain alignment of the tote while being pushed by the tote manipulator. The grip tabs 720, reciprocating bracket 722, and vertically oriented linear actuator, may each be components of a mechanical grabber assembly 728. The mechanical grabber assembly 728 is itself mounted to a horizontal linear actuator 730, which can translate the mechanical grabber assembly from one side of the source tote position 110b to the other. The horizontal linear actuator 730 may include a mounting rail, drive belt, and motor (not shown). The tote manipulator 114 is bidirectional, such that it can grab and place totes on shelves on either side of the robot 100. The tote manipulator 114 may be capable of engaging with different height totes, e.g., 7″, 11″, and 14″ totes.

FIG. 7F shows the example of the tote manipulator 114 with the mechanical grabber assembly 728 at the edge of the source tote position 110b, the reciprocating bracket 722 in the up position, and the outward facing grip tab 720 engaged with the handle on a tote. Thus, the tote manipulator 114 is in position to pull the tote onto the source tote position 110b by moving the mechanical grabber assembly 728 backwards. When the tote manipulator 114 has moved the tote back onto the shelf, the reciprocating bracket will move to the down position, and the grip tab 720 will disengage from the tote handle. If the robot 100 is moving the tote from the source tote position 110b to the order tote queue position 100a, the gripper will also disengage so that the tote transfer mechanism 112 can move the tote. The fully extended state may result in the mechanical grabber assembly 728 being positioned near the edge, at the edge, or even beyond the edge of the elevator carriage 110.

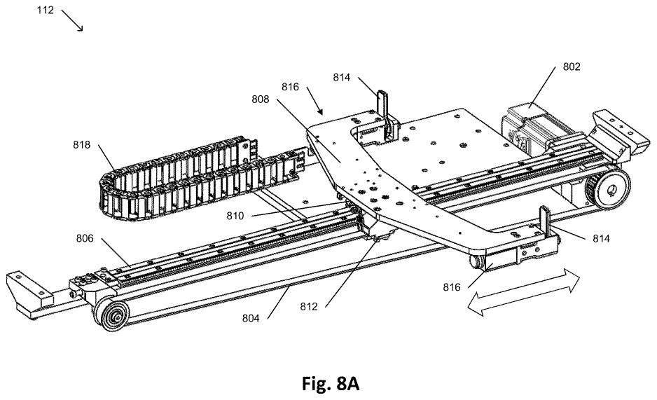

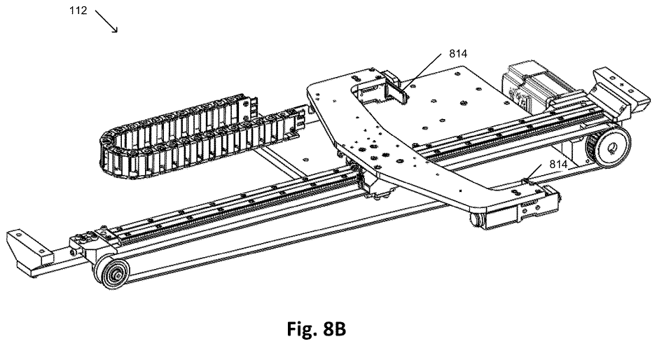

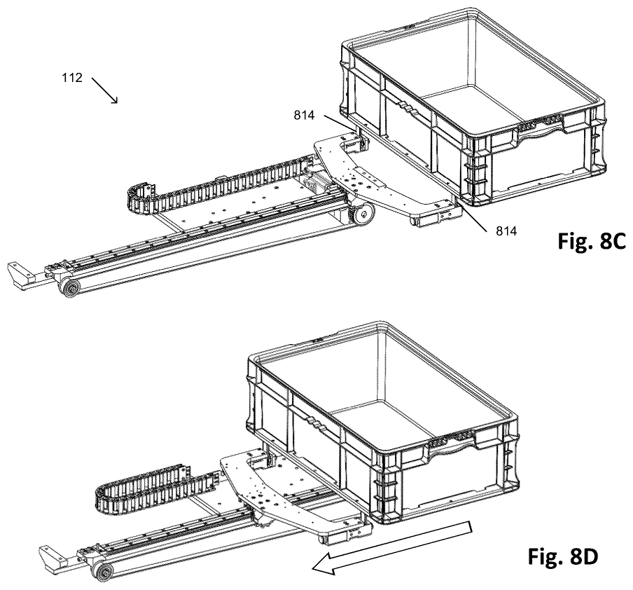

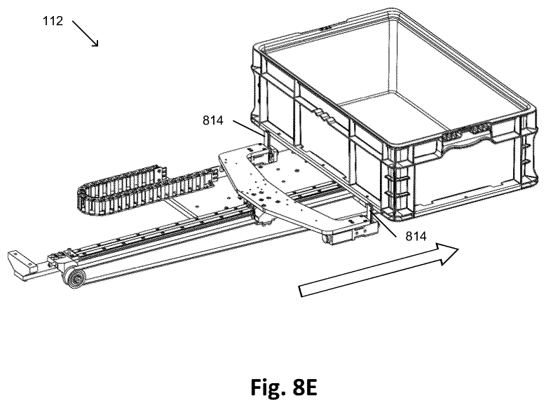

FIGS. 8A-8D show an example embodiment of a tote transfer mechanism 112. As shown in FIG. 8A, the tote transfer mechanism 112 comprises a motor 802 connected to a drive belt 804. Other forms of linear actuators could also be used. Parallel with the drive belt 804 is a linear rail 806. A lateral transfer carriage plate 808 is slidably mounted to the linear rail 806 via a linear bearing 810, and additionally affixed to the drive belt 804 via a belt clamp 812. Thus, when the motor 802 actuates, the drive belt 804 drives the carriage plate 808 along the linear rail 806. Mounted to the carriage plate 808 are one or more (e.g., two) rotatable fingers 814, which have an “up” position, as shown in FIG. 8A, and a “down” position as shown in FIG. 8B. The fingers 814 can toggle between these positions due to finger motor(s) 816, which may be, for example, stepper motors. The tote transfer mechanism 112 also comprises a controller (not shown), which may include a processor and a memory. Control signals from the controller, as well as power, may be delivered to the carriage plate 808 and all motors and sensors thereon, via wires routed through an energy chain 818 or other flexible conduit.

FIG. 8B shows the example of the tote transfer mechanism 112 with fingers 814 in the down position. The fingers 814 may be in the down position when the tote transfer mechanism 112 is not engaging with a tote. The fingers 814 will be in the up position when the tote transfer mechanism 112 is engaging with a tote, to either push or pull or realign it.

FIG. 8C shows the example of the tote transfer mechanism 112 with the fingers 814 in the up position, engaged with the inner surface of the bottom lip of a tote. FIG. 8D shows how, with the fingers 814 engaged with the inner surface of the bottom lip of a tote, the tote transfer mechanism 112 can pull the tote in a direction. Note that in FIG. 8C, the carriage plate 808 is at one end of the linear rail 806. In this configuration, the tote transfer mechanism 112 would be pulling a tote from the tote magazine 106 onto the order tote queue position 110a. Although not shown here, the tote magazine 106 would be on the right side of the page from the reader's perspective.

FIG. 8E shows the example of the tote transfer mechanism 112 with the fingers 814 in the up position, engaged with the outer surface of the bottom lip of a tote. In this configuration, the tote transfer mechanism 112 can push a tote in a direction, as shown by the arrow. Note that in all of FIGS. 8C, 8D and 8E, the fingers 814 are engaging with the bottom lip of the left side of the tote (from the reader's perspective). The fingers can also engage with the bottom lip of the right side of the tote, to push or pull the tote.

For example, to move a tote from the tote magazine 106 to the source tote position 110b, the tote transfer mechanism 112 (via the motor 802) would move the carriage plate 808 to the right (still from the reader's perspective) end of the linear rail 806, with the fingers 814 down. Once the fingers 814 are positioned behind the inner surface of the bottom lip of the left side of the tote, the fingers would rotate up. Then the motor 802 would move the carriage plate 808 to the left end of the linear rail 806, which will cause the fingers 814 to pull the tote to the left. At this point, the tote would be in the order tote queue position 110a. To continue the transfer process, the fingers 814 will flip down, and the carriage plate 808 will move beneath the tote to the right until the fingers 814 are past the outer surface of the right side of the bottom lip of the tote. Then the fingers 814 will flip up, and the carriage plate 808 will move to the left, so that the fingers 814 push the outside surface of the bottom lip of the tote until the tote is in the source tote position 110b. Because the tote transfer mechanism 112 is reversible, the same process can be performed in the opposite direction to move a tote from the source tote position 110b to the order tote queue position 110a to the tote magazine 106. Additionally, the tote transfer mechanism can realign totes that are askew on either the tote magazine 106 or the source tote position 110b by pushing them with the fingers 814 against a back surface.

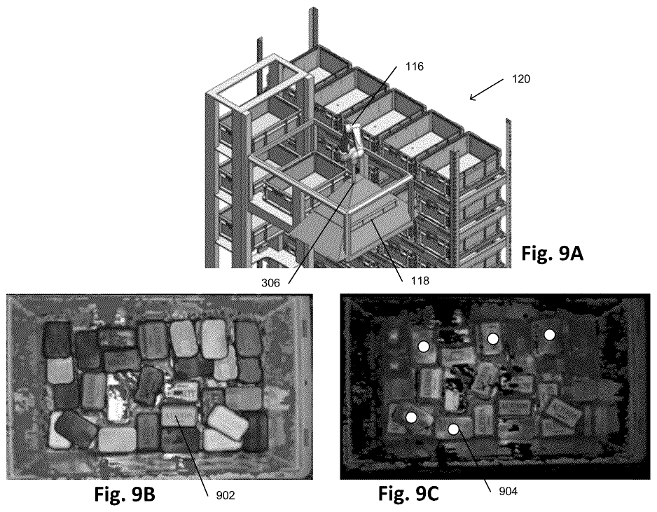

FIG. 9A shows an example of a robot arm 116 scanning or imaging a target source tote 118 which has been pulled from a shelving unit 120. The robot arm 116 comprises an end effector 306, which may have a camera coupled to it, or the camera may be coupled to the robot arm 116 elsewhere. The robot arm camera may, e.g., during a pick operation, scan a target source tote 118, the field of view for which is shown in FIG. 9A as the pyramid shape beneath the end effector 306.

FIG. 9B shows an example of item segmentation performed by the robot 100 during a pick operation. Based on the imaging done by the robot arm camera, the robot 100 may execute software that uses computer vision to identify individual segmented items 902 within the target source tote 118. Item segmentation may enable the robot 100 to determine inventory quantity within a tote as well.

FIG. 9C shows an example of pick targeting performed by the robot 100 during a pick operation. Based on the imaging done by the robot arm camera and the item segmentation, the robot may execute software that uses computer vision to identify, from the one or more segmented items 902, the most accessible items, which will be flagged as pick targets 904. In FIG. 9C, pick targets 904 are shown with a circle on them. The robot arm 116 may be instructed to grab one or more of the pick targets 904 during the pick operation. Scanning, item segmentation, and pick targeting may be used in other workflows as well. For example, the robot arm camera may scan an order tote in the order tote queue position during a place operation.

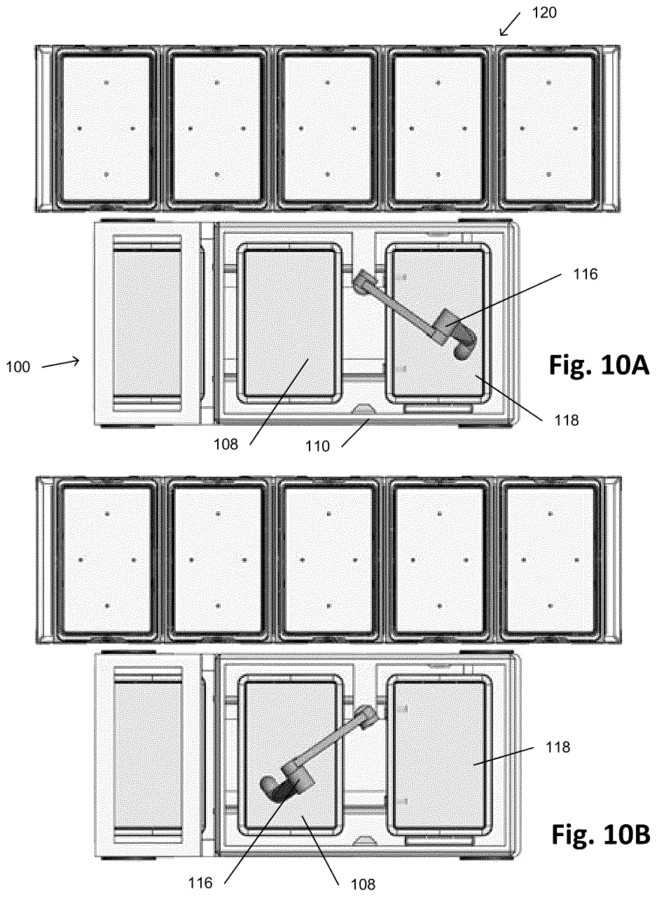

FIGS. 10A and 10B show an example of a robot 100 performing a pick operation using the robot arm 116. The robot 100 is adjacent to a shelving unit 120 and has pulled a target source tote 118 onto the source tote position of the elevator carriage 110. The robot has also positioned an order tote 108 in the order tote queue position. In FIG. 10A, the robot arm is positioned above the target source tote, and may be performing item segmentation, pick targeting, or item picking. In FIG. 10B, the robot arm has picked the item from the target source tote 118 and is placing the item in the order tote 108. If, for example, the order associated with order tote 108 requires multiple items from the target source tote 118, then this process may repeat. If, for example, the robot 100 is performing a place operation, then the item segmentation, pick targeting, and item picking may be done on a replenishment tote in the order tote queue position (which will look like FIG. 10B), and the item will be placed into the target source tote 118 (which will look like FIG. 10A).

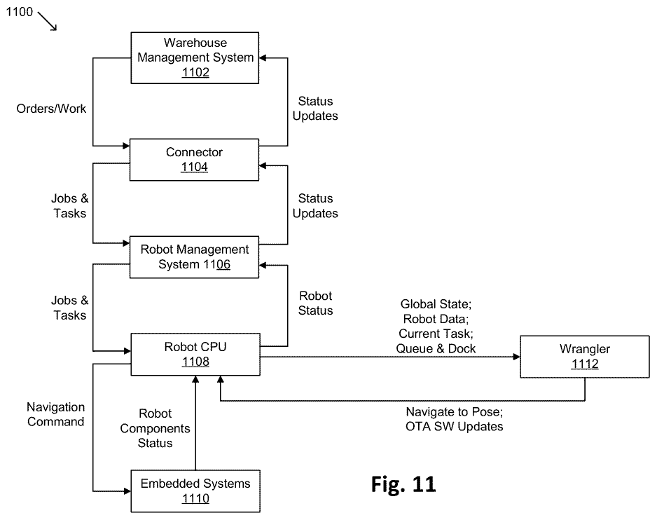

FIG. 11 shows an embodiment of a system architecture 1100 that may be used to control one or more robots 100. The architecture 1100 comprises a warehouse management system 1102 (“WMS”), which, among other things, may track inventory and send orders (or other work) for assignment, such as through the connector 1104. The connector 1104 handles communication between the WMS and the robot management system 1106. The connector 1104 may generate jobs and/or other tasks based on the orders and/or work received from the WMS 1102, and may send those jobs and tasks to the robot management system 1106. The robot management system 1106 manages robot missions and systems, including selecting robots to receive jobs/tasks and assigning those jobs/tasks to the selected robot. The robot management system 1106 may send status updates back through the connector 1104, which sends them to the WMS 1102. The status updates may include information like verifications of job assignments, robot locations, inventory moves, and more.

The robot management system (“RMS”) 1106 may be communicatively coupled to one or more robot CPU's 1108, and may assign jobs and tasks to a robot 100 by sending instructions to the robot CPU 1108. The robot CPU 1108 may provide information relating to the robot's status to the RMS 1106, including, for example, robot location, task completion status, and any detected errors or malfunctions. The robot CPU 1108 communicates with the embedded systems 1110 in the robot 100, which handle low-level control, including, e.g., navigation, planning, and controls. The robot CPU 1108 may send navigation commands to the embedded systems 1110, such as to go to a goal, go to queue location, or to dock. The embedded systems 1110 may provide status information of the robot components to the robot CPU 1108, including information from the wheel encoder, information about the motor current and power, the motor state, power management data, and more. The robot CPU 1108 may communicate to a wrangler server 1112, which manages robot level software planning, controls, queueing and charging. The robot CPU 1108 may send global state information, robot data, the current task, and queue & dock information to the wrangler 1112. The wrangler 1112 may send instructions to navigate to a pose to the robot CPU 708, as well as over-the-air software updates. Any or all of the systems 1102, 1104, 1106, 1108, 1110, and 1112 may be computer systems 1500.

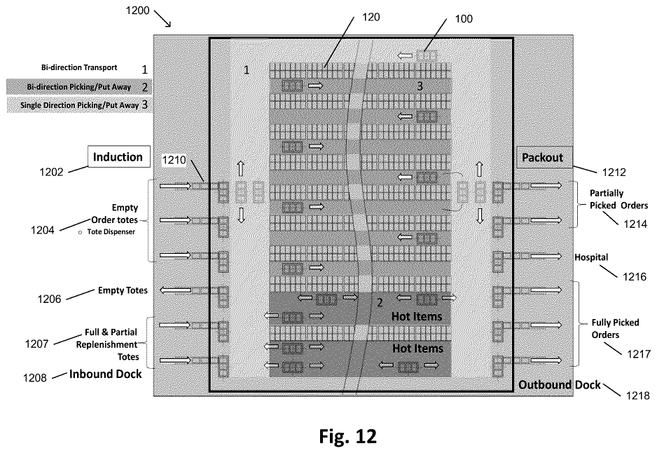

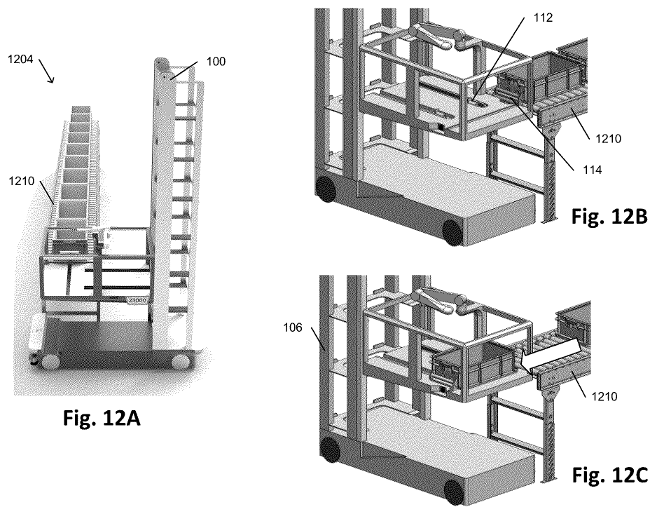

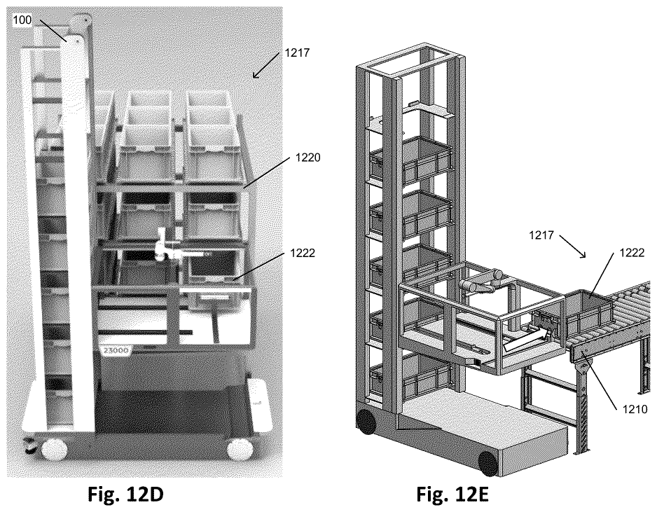

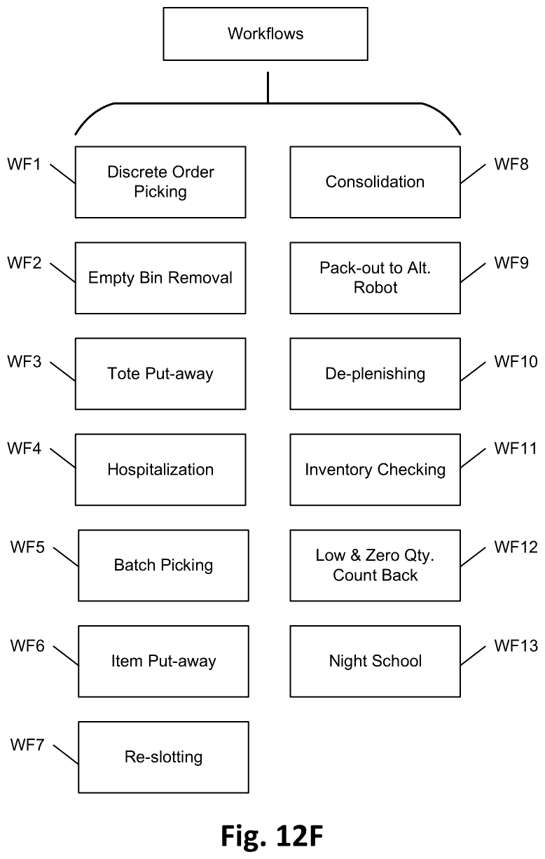

FIG. 12 shows an embodiment of a warehouse system 1200. The warehouse system 1200 may be monitored by a WMS. The warehouse system 1200 comprises three navigable areas. The first navigable area (marked with a 1 and shown in light grey) is the perimeter transport area. This area may be at least two lanes (i.e., robot 100 widths) wide to enable robots to travel bi-directionally and pass each other moving opposite directions. The second navigable area (marked with a 2 and shown in dark grey) is the hot items area, which may be located proximate to the inbound dock 1208 and/or outbound dock 1218. The hot items area may provide access to items with the highest rate of turnover (i.e., items that are ordered most frequently) so that the most frequently accessed items are closest to the docks 1208 & 1218 to minimize the amount of distance traveled and time spent to pick and place these items. The hot items area may be at least two lanes wide to allow for robots to move bi-directionally, maneuver around each other, and to increase the robot capacity in this most-used area. The third navigable area (marked with a 3 and shown in medium grey) is the standard warehouse area. The standard warehouse area may provide access to the majority of items in the warehouse system 1200. It may comprise a plurality of single-lane single-direction rows to maximize the item density. The standard warehouse area may be organized such that more-frequently-accessed items are closer to the inbound and outbound docks 1208 & 1218, and the less-frequently-accessed items are farther from the docks.

Around the outside of the warehouse system 1200, there may be an induction area 1202 and a packout area 1212. The induction area 1202 may comprise a plurality of tote conveyors 1210, including empty order tote dispensers 1204, empty tote receiver(s) 1206, and replenishment tote dispensers 1207, which are proximate to the inbound dock 1208. At the empty order tote dispensers 1204, robots 100 may perform induction (i.e., loading of totes onto the robot) of empty order totes before receiving order instructions and commencing pick operations. At the empty tote receiver 1206, robots may deliver empty source totes that have been pulled from shelves 120 and are in need of replenishment, or replenishment totes that have been depleted of inventory. At the replenishment tote dispensers 1207, totes with fully or partially replenished stock may be inducted onto robots for placement onto shelves 120. At the inbound dock 1208, shipments of inventory may be received and loaded into replenishment totes.

Referring to FIGS. 12A, 12B, and 12C, an example of empty order tote induction is shown. In FIG. 12A, a robot 100 has arrived at a tote conveyor 1210 of an empty order tote dispenser 1204, and has aligned the elevator platform with the edge of the tote conveyor 1210. As FIG. 12B shows, the tote manipulator 114 engages with an empty tote. As FIG. 12C shows, the tote manipulator 114 then retracts to pull the empty tote onto the elevator carriage. After this, the tote transfer mechanism 112 (seen in FIG. 12B) will transfer the empty tote into the tote magazine 106, and then the robot 100 will align the elevator carriage with the tote conveyor 1210 and induct the next tote.

Referring back to FIG. 12, the packout area 1212 may comprise a plurality of tote conveyors 1210 including partially-picked order tote receivers 1214, a hospital 1216, fully-picked order tote receivers 1217, and an outbound dock 1218. At the partially-picked order tote receivers 1214, robots may deliver order totes that contain some, but not all, of the items in an order. This may be due to, e.g., an item running out of stock or because the remaining items are held in a different part of the warehouse. At the hospital 1216, robots may deliver order totes for orders that have encountered an error, such as encountering an “un-pickable item”. The hospital 1216 may be staffed by humans and/or robots who can rectify failed order picks. At the fully-picked order tote receivers 1218, robots may deliver totes containing all of the items in an order for further packaging and shipment to customers at the outbound dock 1218.

Referring to FIGS. 12D and 12E, examples of a robot 100 performing packout are shown. In FIG. 12D, a robot 100 has arrived at a packout shelf 1220, which may be one of a plurality of fully-picked order tote receivers 1217, of a packout area 1212. The robot 100 has transferred a fully-picked order tote 1222 from the tote magazine to the source tote position on the elevator carriage, and is in the process of placing the fully-picked order tote 1222 onto the packout shelf 1220. In FIG. 12E, which is another example, a robot 100 has arrived at a tote conveyor 1210 of a fully-picked order tote receiver 1217. Similarly, the robot 100 has transferred a fully-picked order tote 1222 from the tote magazine to the source tote position on the elevator carriage, and is in the process of placing the fully-picked order tote 1222 onto the tote conveyor 1210.

### Exemplary Workflows

As shown in FIG. 12F, the robot 100 may be capable of performing a variety of exemplary workflows.

One such workflow is discrete order picking WF1, which may be one of three variations. In a first variation, one SKU unit is to be picked from a source tote and placed in a single order tote. In a second variation, two or more SKU units are to be picked from a source tote and placed in a single order tote. In a third variation, two or more SKU units are to be picked from a source tote and placed in two or more order totes. In this third variation, the robot 100 may, after placing the item(s) from the source tote (in the source tote position 110b) into the first order tote, move the first order tote back onto the tote magazine 106, move the second order tote from the tote magazine 106 into the order tote queue position 110a, place the item(s) from the source tote into the second order tote, and then move the second order tote back onto the tote magazine 106 and place the source tote back onto the shelf.

Another workflow example is empty bin removal WF2. When, for example, a source tote has been depleted of items, it may be optimal to remove the empty source tote from the shelf. A robot may receive notice from a WMS that a source tote is now empty, and/or may identify that a source tote is empty using the robot arm vision system described above in relation to FIGS. 9A-9C. Based on this identification, a robot (which may be the same robot or a different robot) may be assigned an empty bin removal workflow. To execute the workflow, the robot will navigate to the location of the empty bin (optionally pre-queueing the elevator height), pull the empty bin onto the source tote position of the elevator using the tote manipulator, move the elevator to the height of a designated tote magazine position, and then transfer the empty bin to the designated tote magazine position. In the event that there are multiple empty bins in close proximity, e.g., the same shelf column, shelf row, or shelving unit, the robot may move the first empty bin to the order tote queue position before pulling the second empty bin onto the source tote position. Then the robot may place the empty bins into their selected tote magazine positions. If all tote magazine positions are full, the robot may travel with the empty bin(s) remaining on the elevator carriage.

Another workflow example is tote put-away WF3. When, for example, there are empty spots on shelves, a robot may be used to replenish those spots with totes. To execute this workflow, the robot may induct, i.e., fill its tote magazine and/or elevator carriage with, one or more full totes. The robot will then travel to each empty shelf spot and place the corresponding full tote into the designated shelf spot. The robot may pre-queue on the way to each empty shelf spot.

Another workflow example is “hospitalization” WF4. A warehouse may have a designated location for remedying inventory errors called a “hospital”, such as hospital 1216. In one example, a source tote on a shelf may be deemed “unpickable” after a certain number of failed pick attempts by a robot. The robot may then replace the unpickable source tote back on the shelf and flag it as unpickable to the WMS, which will route remaining orders requiring the items in the unpickable tote to alternate source tote locations or to the hospital. The order tote, which is now short the item from the unpickable tote, may be kept on the robot and dropped off at the hospital after all the fully picked order totes have been packed out. A human or utility bot may retrieve the unpickable tote and bring it to the hospital, where picking may be done manually and/or the source of the error may be resolved.

Another workflow example is batch picking WF5. A robot may be capable of picking higher volumes of SKU units to a single order tote to be sorted outside the robot into unique orders. In one example, a robot may pick a batch of items and put them in one order tote. In another example, a robot may pick multiple batches of items and put them into one or more order totes. If multiple batches are put into one order tote, the order tote may be subdivided to keep the items organized.

Another workflow example is item put-away WF6. An item put-away workflow functions similarly to a picking workflow in reverse. A robot will be inducted with one or more totes full of items to be placed into source totes. The robot will then travel to one or more destination locations, optionally pre-queueing on the way, in order to pull the target source tote off the shelf and onto the elevator carriage, place items from the order tote (in the order tote queue position) into the target source tote using the robot arm, and then place the target source tote back on the shelf before continuing to the next destination. Item put-away workflows are used to replenish warehouse shelf stock.

Another workflow example is tote re-slotting WF7. A robot may be capable of moving filled or partially filled totes from one racking location to another. For example, if a particular item has received a surge in orders, its tote(s) may be moved from a far end of the warehouse to a “hot items” section, nearer to the pack-out stations. The robot may take the particular tote(s) and move them to their target destination.

Another workflow example is consolidation WF8. The robot may pick remaining items from partially filled totes and place them into partially filled totes elsewhere to consolidate material. This may be optimal when, for example, two source totes containing fungible items are each half full or less.

Another workflow example is pack-out to an alternate robot WF9. The robot 100 may be capable of delivering totes to humans or other robots (e.g., robots that are not like the robot 100) when, for example, items have been ordered that are not on shelves accessible to the robot 100 and must be picked by other means.

Another workflow example is “de-plenishing” WF10. In this example, a robot may remove specified totes from the warehouse system in order to improve performance and efficiency by freeing up space.

Another workflow example is automated inventory checking WF11. A robot may (e.g., during downtime or on demand) check the quantity of items in a source tote by pulling the source tote and picking each item into a queued order tote while counting them, and then place them each back into the source tote while counting them again. If the robot encounters a discrepancy between these counts, it may repeat the process. In a particular example, a robot may perform “low & zero quantity count back” WF12, in which case the robot may use only the arm camera to count inventory in a source tote when there are few enough items such that the items are not obscured. This type of counting can build confidence over time as in-tote quantities are low and likely jostled by repeated tote extraction and replacement.

Another workflow example is “night school” WF13. A robot may be capable of executing pick training on selected products. For example, low pick success SKU's may be identified and prioritized to enable robots to train (e.g., with machine learning) on picking during robot or warehouse downtime. This can also be used to train on new items in the system proactively.

### Picking Prioritization

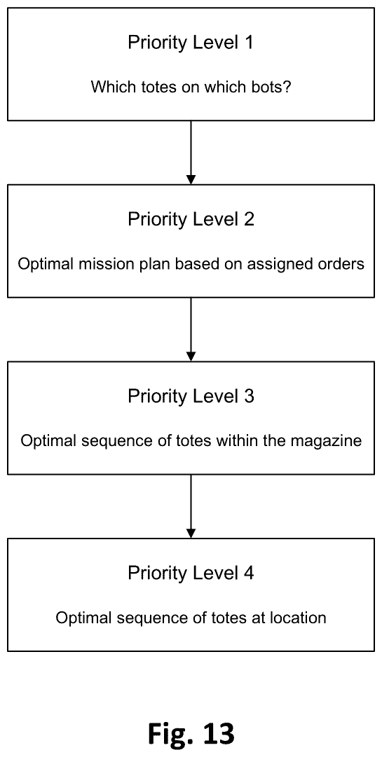

The WMS 1102, the robot management system 1106 and/or the robot 100 may improve efficiency by prioritizing item picking at various levels. FIG. 13 shows an embodiment of four levels of prioritization within a workflow (a.k.a. “mission”). At priority level 1, the robot management system (RMS) 1106, for example, determines which totes to assign to which robots by taking into account the available order pool, the age of each order, the number of robots available and the number of tote magazine slots available on those robots, and the locations of the items in the available orders including relative distances between them. Given these inputs, the RMS may assign orders to particular robots such that the orders assigned to each robot reduce total mission time for the order pool. For example, one robot may be assigned orders corresponding to items that are all located within a particular region of the warehouse, which makes the most efficient use of the travel time spent reaching that region of the warehouse. Predicted congestion may also be avoided-the RMS may avoid assigning orders to multiple robots that will cause more than a threshold number of robots to be within a certain proximity during the mission. Methods for order grouping as described in U.S. Pat. No. 10,572,854 (the contents of which are incorporated, in entirety, by reference), may be utilized.

At priority level 2, mission path planning may be optimized to minimize the overall mission time. Given the list of items for a robot to collect, the mission path through the warehouse may be determined such that the robot will minimize back-tracking and unnecessary travel. As part of this optimization, the sequence of pick (or place) items may be determined.

At priority level 3, the sequence of order totes within the tote magazine may be determined in such a way as to minimize tote elevator movement during the mission. For example, there may be an algorithm to minimize elevator travel based on the planned mission path, accounting for sequence of picking. This level of priority may influence the placement of order totes on the tote magazine during induction. For example, order totes assigned to orders that correspond to items that are mostly located on low shelves may be placed on a low slot in the tote magazine, and vice versa for items on high shelves.

Therefore, when the robot is pre-queueing and executing the pick/place operation, the elevator does not need to move very far.

At priority level 4, the sequence of totes at a location may be determined such that time spent at the location is minimized. For example, at a particular location, there may be multiple order totes requiring items from source totes located within the same column on a shelf. If one of the multiple order totes was most recently picked into, then the robot may leave that order tote in the order tote queue position 110a and prioritize the queued order tote's pick at the location. Therefore the robot can avoid wasting time by placing the order tote back into the tote magazine only to soon pull it from the tote magazine again. The robot may also avoid wasting time by leaving a source tote, from which multiple orders require an item, in the source tote position 110b, while the robot arm picks items from the source tote into each of the order totes.

In an example, imagine a robot carrying a plurality of order totes arrives at a location and aligns itself with a column of source totes on a shelving unit. Order tote 1 requires an item from source tote A; order tote 2 requires items from source tote B and source tote C; and order tote 3 requires items from source tote A and source tote C. The prioritizing system may command the robot such that it pre-queues order tote 1 on the way to the shelf and aligns the elevator with the height of the shelf holding source tote A. The robot may then pull source tote A and pick an item from it into order tote 1. Then order tote 1 will be placed back into the tote magazine and order tote 3 will be pulled into the order tote queue position so that an item may be picked from source tote A into order tote 3. Source tote A will then be replaced and source tote C will be pulled, and an item will be picked into order tote 3 before order tote 3 is replaced into the tote magazine. Order tote 2 will then be pulled and an item will be picked from source tote C into order tote 2 before source tote C is replaced onto the shelf. Lastly, source tote B will be pulled on the source tote position of the elevator and an item will be picked from source tote B and placed into order tote 2, before order tote 2 is placed back into the tote magazine and source tote B is placed back on the shelf. This pick sequence was optimized such that no totes were pulled onto the elevator more than once and time spent at the location was minimized.

Other examples of tote sequence optimization/prioritization are possible as well.

### Source Tote and Item Location

FIG. 14A shows an embodiment of a pick location within a warehouse system 1200. There is shown a target source tote 118 on a shelf 122 of a shelving unit 120. The shelving unit 120 may have a shelving unit fiducial label 1402, which, when scanned by a robot, allows the robot to determine that it has reached the location of the shelving unit 120, including which side of the shelving unit 120. The target source tote 118 has a shelf position number 1404, which indicates the horizontal position on the shelving unit 120, and a shelf level number 1406, which indicates the vertical position on the shelving unit 120. When a robot is assigned a task of, e.g., picking an item from target source tote 118, the assignment may include a location number comprising a shelving unit number and shelving unit side number (found on the shelving unit fiducial label 1402), a shelf position number 1404, and a shelf level number 1406. If a shelving unit 120 is only one tote deep, the source totes may be accessible from either side of the shelving unit 120 and have two opposing external surfaces.

In some cases, totes may be subdivided as shown in FIG. 14B, in which case the location number may include a tote position number 1410 and a tote row number 1412, which, combined, identify the target tote section 1414. Totes, including the target source tote 118, may have tote identification labels 1408 and 1409, which indicate the particular tote and each side of the tote. The tote identification labels 1408 and 1409 allow the robot to determine the orientation of the tote so that the robot arm can pick from and/or place to the correct tote section. It is important that the robot 100 can determine whether a tote is pulled from one side of a shelf or another, so it knows the orientation of the tote sections in the tote. If the robot 100 pulls a target source tote 118 from one side of a shelving unit 120, the target source tote 118 will have a first orientation, and if the robot 100 pulls the tote from the other side of the shelving unit 120, the target source tote 118 will have a second orientation.

Depending on the orientation of the target source tote 118, the tote sections will have different positional orientations relative to the robot arm. target tote The robot may scan tote identification labels (e.g., with a camera 115, shown in FIG. 1B) during induction and during workflows to identify totes on shelves. The tote identification labels may also aid in fine position adjustment by the robot to align the platform of the elevator carriage with a shelf, conveyor belt, etc. All labels may include, e.g., barcodes, QR codes, RFID, or other machine-readable identifiers, optionally in addition to human-readable identifiers.

### Exemplary Computer System

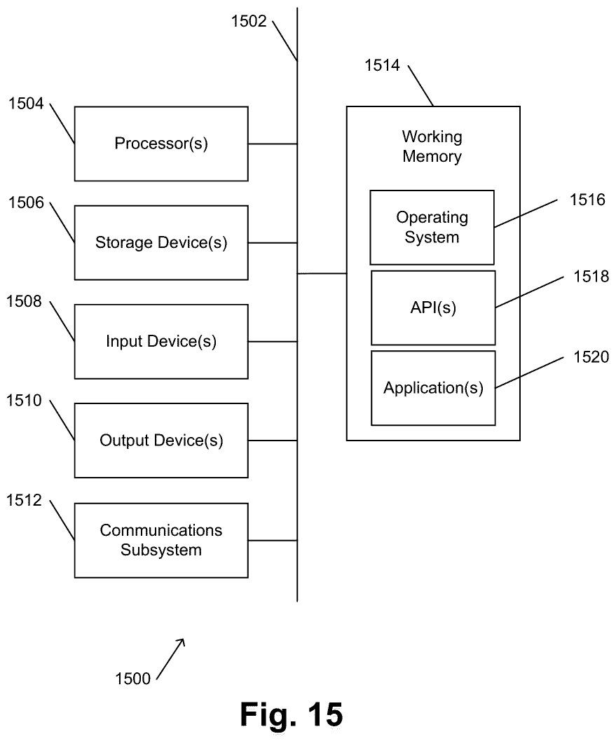

Referring to FIG. 15, an example computer system 1500 is shown. The computer system 1500 as illustrated in FIG. 15 may incorporate as part of any previously described computer devices, including the robot controller, or subsequent devices. FIG. 15 provides a schematic illustration of one embodiment of the computer system 1500 that can perform the methods provided by various other embodiments, as described herein, and/or can function as the host computer system, or other networked computer system. In an example, the computer system 1500 may be included in a cloud environment such as the Amazon AWS platform and the operations and function described herein may be distributed over different computer systems 1500 operating in different locations. It should be noted that FIG. 15 is meant only to provide a generalized illustration of various components, and or all of which may be utilized as appropriate. FIG. 15, therefore, broadly illustrates how individual system elements may be implemented in a relatively separated or relatively more integrated manner.

The computer system 1500 is shown comprising hardware elements that can be electrically coupled via a bus 1502 (or may otherwise be in communication, as appropriate). In an example, the bus 1502 may be configured as one or more communication channels in a cloud-computing environment. The hardware elements may include one or more processors 1504, including without limitation one or more general-purpose processors and/or one or more special-purpose processors (such as digital signal processing chips, graphics acceleration processors, and/or the like); one or more input devices 1508, which can include without limitation a mouse, a keyboard, a touchscreen and/or the like; and one or more output devices 1510, which can include without limitation a display device, a printer and/or the like.

The computer system 1500 may further include (and/or be in communication with) one or more non-transitory storage devices 1506, which can comprise, without limitation, local and/or network accessible storage, and/or can included, without limitation, a disk drive, a drive array, an optical storage device, solid-state storage device such as random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1500 might also include a communications subsystem 1512, which can include without limitation a modem, a network card (wireless or wired), an infrared communication device, a wireless communication device and/or chipset (such as a Bluetooth® device, an 802.11 device, a WiFi device, a WiMax device, cellular communication facilities, etc.), and/or the like. The communications subsystem 1512 may permit data to be exchanged with a network (such as the network described below, to name one example), other computer systems, and/or any other devices described herein. In many embodiments, the computer system 1500 will further comprise a working memory 1514, which can include a RAM or ROM device, as described above.

The computer system 1500 also can comprise software elements, shown as being currently located within the working memory 1514, including an operating system 516, device drivers, executable libraries, and/or other code, such as one or more application programs 1520, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods. In a cloud computing implementation, the working memory may include one or more application programming interfaces (APIs) 1518 configured to send and receive data and instructions to and from other networked stations. For example, the API(s) 1518 may be an example of an API.

A set of these instructions and/or code might be stored on a computer-readable storage medium, such as the storage device(s) 1506 described above. In some cases, the storage medium might be incorporated within a computer system, such as the computer system 1500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 1500 and/or might take the form of source and/or installable code, which, upon compilation and/or installation on the computer system 1500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1500) to perform methods in accordance with various embodiments of the disclosure. According to a set of embodiments, some or all of the procedures of such methods are performed by the computer system 1500 in response to processor 1504 executing one or more sequences of one or more instructions (which might be incorporated into the operating system 1516 and/or other code, such as an application program 1520) contained in the working memory 1514. Such instructions may be read into the working memory 1514 from another computer-readable medium, such as one or more of the storage device(s) 1506. Merely by way of example, execution of the sequences of instructions contained in the working memory 1514 might cause the processor(s) 1504 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1500, various computer-readable media might be involved in providing instructions/code to processor(s) 1504 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 1506. Volatile media include, without limitation, dynamic memory, such as the working memory 1514. Transmission media include, without limitation, coaxial cables, copper wire and fiber optics, including the wires that comprise the bus 1502, as well as the various components of the communication subsystem 1512 (and/or the media by which the communications subsystem 1512 provides communication with other devices).

Various forms of computer-readable media may be involved in carrying one or more sequences of one or more instructions to the processor(s) 1504 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1500.

The communications subsystem 1512 (and/or components thereof) generally will receive the signals, and the bus 1502 then might carry the signals (and/or the data, instructions, etc. carried by the signals) to the working memory 1514, from which the processor(s) 1504 retrieves and executes the instructions. The instructions received by the working memory 1514 may optionally be stored on a storage device 1506 either before or after execution by the processor(s) 1502.

The robot 100 may comprise one or more controllers, each of which may be a computer system 1500, and/or may comprise one or more processors (of any suitable kind) and memory. The controller(s) may be configured to communicate with a WMS 1102, other controllers, motors, sensors, computers, servers, and/or user input devices.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. An autonomous mobile robot for use in a warehouse including one or more storage units for holding a plurality of source totes each associated with one or more items, the autonomous mobile robot comprising:
a mobile robot base including a base body having a top surface, a controller, and a plurality of wheels;
a tote structure disposed on the top surface of the base body, the tote structure including:
a tote magazine having a plurality of positions vertically disposed relative to the top surface of the base body, each position configured to hold at least one order tote;
a tote elevator having a platform positioned adjacent to the tote magazine; wherein the platform includes a first surface portion configured to receive a source tote retrieved from the one or more storage units and a second surface portion adjacent to the first surface portion and configured to receive an order tote from the tote magazine and;
a lift mechanism, responsive to the controller, configured to raise and lower the tote elevator relative to the top surface of the base body.

2. The autonomous mobile robot of claim 1 wherein the first surface portion of the platform includes a tote manipulator mechanism, responsive to the controller, to extend from a retracted position to an extended position and to retract from the extended position to the retracted position; and wherein a direction of travel of the tote manipulator mechanism is perpendicular to a length of the platform.

3. The autonomous mobile robot of claim 2 wherein the tote manipulator mechanism, responsive to the controller, is configured to engage with a storage tote of the plurality of storage totes when in the extended position and to retract the engaged storage tote to the retracted position on the first surface portion of the platform.

4. The autonomous mobile robot of claim 3 wherein the tote manipulator mechanism includes a tote manipulator device configured to engage with the storage tote; the tote manipulator device connected to a translation device configured to move the tote manipulator device in a direction perpendicular to the length of the platform.

5. The autonomous mobile robot of claim 4 wherein the second surface portion includes a tote transfer mechanism, responsive to the controller, configured to move in a direction parallel to the length of the platform from proximate the tote magazine across the second surface portion to the first surface portion.

6. The autonomous mobile robot of claim 5 wherein the tote transfer mechanism includes at least one projection configured to engage an order tote positioned in the tote magazine, the at least one projection connected to a translation device configured to transfer the order tote from the tote magazine to the second surface portion on the platform and from the second surface portion on the platform to the tote magazine.

7. The autonomous mobile robot of claim 6 wherein the tote elevator is configured to be raised and lowered by the lift mechanism, responsive to the controller, to selectively align the second surface portion of the platform with each of the vertically disposed positions of the tote magazine.

8. The autonomous mobile robot of claim 7 wherein the tote elevator includes a robotic pick arm having an imaging system and a gripper device, the robotic pick arm being disposed above the surface of the platform and secured to a mounting mechanism.

9. The autonomous mobile robot of claim 8 wherein the mounting mechanism, responsive to the controller, is configured to move the robotic pick arm between the first surface portion and the second surface portion of the platform.

10. The autonomous mobile robot of claim 9 wherein the controller is configured to:
navigate the mobile robot base to a position adjacent to a storage unit having a source tote associated with an identified item;
cause the lift mechanism to align the platform of the elevator with a height of a position of the plurality of vertically disposed positions in the tote magazine having an order tote associated with the identified item;
cause the tote transfer mechanism to retrieve the order tote from the position in the tote magazine and move the retrieved order tote to the second surface portion of the platform;
cause the lift mechanism to align the platform of the elevator with a height of the source tote on the storage unit; and
cause the tote manipulator mechanism to engage the source tote and retract the source tote to the retracted position on the first surface portion of the platform.

11. The autonomous mobile robot of claim 10 wherein the controller is configured to:
cause the robot pick arm to locate the identified item using the imaging system in one of the source tote or the order tote and pick the identified item using the gripper device; and
cause the robot pick arm to move to the other of the source tote or the order tote and to drop the identified item from the gripper device into the other of the source tote or the order tote.

12. The autonomous mobile robot of claim 1 wherein the plurality of wheels are mecanum wheels.

13. An autonomous mobile robot for use in a warehouse including one or more storage units for holding a plurality of source totes each associated with one or more items, the autonomous mobile robot comprising:
a mobile robot base including a base body having a top surface, a controller, and a plurality of wheels;
a tote structure disposed on the top surface of the base body, the tote structure including:
a tote magazine having a plurality of positions vertically disposed relative to the top surface of the base body, each position configured to hold at least one order tote;
a tote elevator having a platform positioned adjacent to the tote magazine; wherein the platform includes a first surface portion configured to receive a source tote retrieved from the one or more storage units and a second surface portion adjacent to the first surface portion and configured to receive an order tote from the tote magazine; and
A lift mechanism, responsive to the controller, configured to raise and lower the tote elevator relative to the top surface of the base body;
wherein the first surface portion of the platform includes a tote manipulator mechanism, responsive to the controller, to extend from a retracted position to an extended position and to retract from the extended position to the retracted position; and wherein a direction of travel of the tote manipulator mechanism is perpendicular to a length of the platform
wherein the second surface portion includes a tote transfer mechanism, responsive to the controller, configured to move in a direction parallel to the length of the platform from proximate the tote magazine across the second surface portion to the first surface portion.

14. The autonomous mobile robot of claim 13 wherein the tote manipulator mechanism, responsive to the controller, is configured to engage with a storage tote of the plurality of storage totes when in the extended position and to retract the engaged storage tote to the retracted position on the first surface portion of the platform.

15. The autonomous mobile robot of claim 14 wherein the tote manipulator mechanism includes a tote manipulator device configured to engage with the storage tote; the tote manipulator device connected to a translation device configured to move the tote manipulator device in the direction perpendicular to the length of the platform.

16. The autonomous mobile robot of claim 15 wherein the tote transfer mechanism includes at least one projection configured to engage an order tote positioned in the tote magazine, the at least one projection connected to a translation device configured to transfer the order tote from the tote magazine to the second surface portion on the platform and from the second surface portion on the platform to the tote magazine.

17. The autonomous mobile robot of claim 16 wherein the tote elevator is configured to be raised and lowered by the lift mechanism, responsive to the controller, to selectively align the second surface portion of the platform with each of the vertically disposed positions of the tote magazine.

18. The autonomous mobile robot of claim 17 wherein the tote elevator includes a robotic pick arm having an imaging system and a gripper device, the robotic pick arm being disposed above the surface of the platform and secured to a mounting mechanism.

19. The autonomous mobile robot of claim 18 wherein the mounting mechanism, responsive to the controller, is configured to move the robotic pick arm between the first surface portion and the second surface portion of the platform.

20. The autonomous mobile robot of claim 19 wherein the controller is configured to:
navigate the mobile robot base to a position adjacent to a storage unit having a source tote associated with an identified item;
cause the lift mechanism to align the platform of the elevator with a height of a position of the plurality of vertically disposed positions in the tote magazine having an order tote associated with the identified item;
cause the tote transfer mechanism to retrieve the order tote from the position in the tote magazine and move the retrieved order tote to the first surface portion of the platform;
cause the lift mechanism to align the platform of the elevator with a height of the source tote on the storage unit; and
cause the tote manipulator mechanism to engage the source tote and retract the source tote to the retracted position on the second surface portion of the platform.

21. The autonomous mobile robot of claim 20 wherein the controller is configured to:
cause the robot pick arm to locate the identified item using the imaging system in one of the source tote or the order tote and pick the identified item using the gripper device; and
cause the robot pick arm to move to the other of the source tote or the order tote and to drop the identified item from the gripper device into the other of the source tote or the order tote.

22. The autonomous mobile robot of claim 15 wherein the plurality of wheels are mecanum wheels.
